(19) United States
(12) Patent Application Publication
(10) Pub. No.: US 2008/0000735 A1
(43) Pub. Date: Jan. 3, 2008

(54) Braking device for a power winch

(76) Inventor: Shih Jyi Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/476,843

(22) Filed: Jun. 29, 2006

(51) Int. Cl. B60T 13/04

(52) U.S. Cl. 188/171; 254/378

(57) ABSTRACT

A braking device for a power winch includes a reduction box installed inside with a sectional shaft, an elastic member, a fixing base, a braking lining, a first engraved block, a second engraved block and a clutch base. The fixing base is fixed in the accommodating hollow of the reduction box. The braking lining is an independent component composed of at least two blocks integrated to form a ring-shaped braking lining assembled in the accommodating hollow and positioned abutting the inner edge of the accommodating hollow, the fixing base and the first engraved block, having a small gap formed between them. Only when the motor stops operating and the power winch performs braking, will the braking lining produce friction with the inner edge of the accommodating hollow, the fixing base and the first engraved block, able to prolong service life and facilitate replacing of the braking lining.

### BACKGROUND OF THE INVENTION

1. Field of the Invention

This invention relates to a braking device for a power winch, particularly to one provided with an independent braking lining composed of at least two blocks. The braking lining is assembled in the accommodating hollow of a reduction box and positioned between the accommodating hollow and a fixing base as well as a first engraved block. The braking lining is under a floating state before carrying out braking, able to lessen wear and prolong service life, having beneficial result in use and convenient in replacing of the braking lining. When pushed by the first engraved block to move to carry out braking, the braking lining will simultaneously contact with the inner edge of the accommodating hollow and the fixing base as well as the first engraved block to perform braking, able to attain excellent effect of braking.

2. Description of the Prior Art

Generally, a braking device for a power winch must be able to stop the motor timely and carry out braking instantly whether the power winch is not in use or is slinging up and lowering down heavy loads. However, when a conventional power winch is normally driven by a motor to hoist or lower the steel rope (whether there is heavy loads hung thereon), the braking action will automatically be released for smoothly hoisting and lowering the steel rope. A braking device for a power winch, as disclosed in a U.S. Pat. No. 6,520,486, titled “BRAKING DEVICE FOR MOTIVE WINCH”, which was a patent of the inventor of the present invention, includes a reduction box provided therein with a sectional shaft, an elastic member, a first engraved block, a second engraved block and a clutch base. The first engraved block is fitted on the sectional shaft but unable to drive each other and has its outer circumferential edge secured with a braking lining able to contact with or disengage from the frictional surface preset in the reduction box. The elastic member is assembled on the first engraved block, able to produce proper reverse twisting force relative to the first engraved block; therefore, when the braking lining on the first engraved block is in a motionless state, it will be forced to push against the frictional surface formed in the reduction box, ready to carry out braking. The second engraved block is engaged with the sectional shaft for rotating synchronously. The first and the second engraved block are respectively formed with a different slope able to closely contact with each other for pushing the braking lining of the first engraved block to move and perform or release braking, and also respectively formed actuating projections to be actuated to rotate by the projecting blocks fixed on the inner side of the clutch base. The clutch base is driven to rotate by the motor spindle, which is inserted through the sectional shaft (but unable to drive each other) and has its outer end connected with the clutch base. Thus, when the motor is operated, its motor spindle will actuate the clutch base and the two engraved blocks to rotate together to let the braking lining move away from the frictional surface in the reduction box and release braking so as to enable the steel rope to be hoisted or lowered smoothly. When the motor stops operating, the reaction draw force coming from the heavy loads hung on the steel rope will force the slope of the second engraved block to push the slope of the first engraved block to actuate the first engraved block and the braking lining on its outer circumferential edge to move and closely contact with the frictional surface in the reduction box, thus attaining effect of braking.

Designed in this way, the braking device for a motive winch in this US patent has the following defects.

1. When the motor is operated, the clutch base will actuate the first and the second engraved block to rotate synchronously, and the braking lining assembled on the first engraved block will always be rotated together with the first engraved block, easy to cause wear to the braking lining.

2. The braking lining is firmly secured on the outer circumferential edge of the first engraved block; therefore, in case the braking lining has to be replaced with a new one, both the braking lining and the first engraved block have to be replaced together, inconvenient in use and not conforming to economic gain.

### SUMMARY OF THE INVENTION

The objective of this invention is to offer a braking device for a winch, including an independent braking lining composed of at least two blocks to be assembled in the accommodating hollow of a reduction box and positioned between the accommodating hollow and a fixing base as well as a first engraved block. The braking lining is under a floating state before performing braking, able to lessen wear and prolong service life, enhancing effect on use and facilitating replacing of the braking lining. When the braking lining is pushed by the first engraved block to move for carrying out braking, it will simultaneously contact with the inner edge of the accommodating hollow and the fixing base as well as the first engraved block and carry out braking, able to achieve excellent effect of braking.

The braking device for a power winch in the present invention includes a reduction box, a fixing base, a braking lining, a sectional shaft, an elastic member, a first engraved block, a second engraved block, a clutch base and a reduction box rear cover combined together.

The reduction box to be secured on a power winch is installed with a reduction gear set in the interior and bored at one side with an accommodating hollow having its inner edge formed with a frictional surface. The reduction box is further bored with an insert hole in the center for a motor spindle to pass therethrough, and the reduction gear set is received in the central insert hole.

The fixing base is fixed in the accommodating hollow of the reduction box and formed with a frictional surface.

The braking lining is composed of at least two blocks arranged together to form a ring-shaped braking lining to be assembled in the accommodating hollow of the reduction. The braking lining is positioned abutting against the frictional surface of the inner edge of the accommodating hollow and the frictional surface of the fixing base, with a little gap formed between them.

The sectional shaft is fitted on the motor spindle and inserted in the insert hole of the reduction box. The sectional shaft has the annular wall of its opposite ends formed with teeth, and the teeth on the annular wall of one end, which is inserted in the insert hole, are engaged with the reduction gear set in the reduction box for rotating together

The elastic member to be fitted on the sectional shaft has one end inserted and positioned in the hole of the sectional shaft

The first engraved block is fitted on the sectional shaft, with the other end of the elastic member inserted and positioned in the first engraved block. The first engraved block has a protruding annular base fixed on one side reverse to the elastic member, and the annular base is formed with plural corrugated slopes and has its opposite outer walls respectively disposed with an actuating projection. Further, the first engraved block has its outer circumferential edge formed with a frictional surface abutting the braking lining, letting the braking lining positioned between the accommodating hollow and the fixing base as well as the first engraved block.

The second engraved block is formed with a central hole having its inner wall provided with teeth to be engaged with the teeth on the annular wall of the outer end of the sectional shaft. The second engraved block is provided with a slope and two actuating projections respectively corresponding with the slope and the actuating projections of the first engraved block, only there is slight angle error between the slopes and between the actuating projections.

The clutch base is bored with an engage hole in the center of its outer end for the outer end of the motor spindle to be engaged and combined therein. The clutch base has its inner side disposed with two projecting members for pushing the actuating projections of the first and the second engraved block.

The reduction box rear cover is locked on the reduction box.

The braking lining is an independent component assembled in the accommodating hollow of the reduction box and positioned between the inner edge of the accommodating and the frictional surface of the fixing base as well as the frictional surface of the first engraved block, and before performing braking, the braking lining is under a floating state. When the motor stops operating, the first engraved block will be moved to have its frictional surface closely contacting with the braking lining to produce friction, and the blocks of the braking lining will be pressed to move and contact with the frictional surface of the fixing base and the frictional surface on the inner edge of the accommodating hollow for carrying out braking.

### BRIEF DESCRIPTION OF DRAWINGS

This invention will be better understood by referring to the accompanying drawings, wherein:

FIG. 1 is an exploded perspective view of a braking device for a power winch in the preset invention;

FIG. 2 is a cross sectional view of the braking device for a power winch in the preset invention;

FIG. 3 is a side cross-sectional view of the braking lining composed of three blocks assembled together with the reduction box and the fixing base in the preset invention; and

FIG. 4 is a side cross-sectional view of the braking lining composed of four blocks assembled together with the reduction box and the fixing base in the present invention.

### DETAILED DESCRIPTION OF THE PREFERRED EMBODIMENT

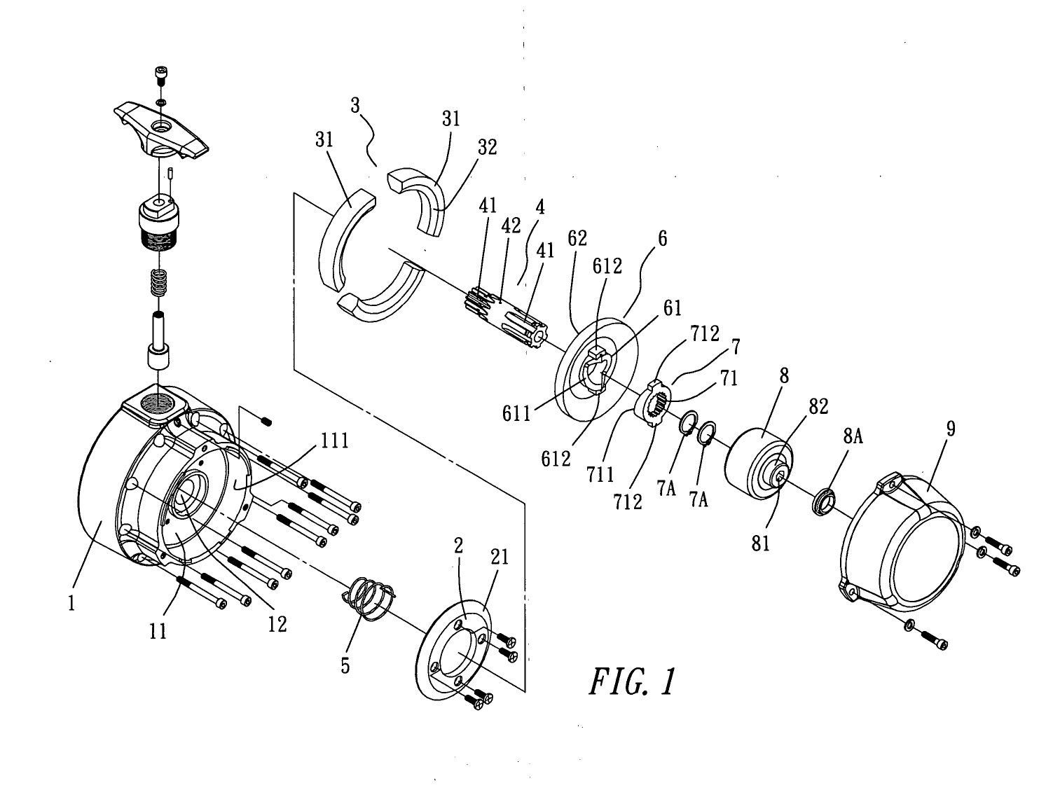

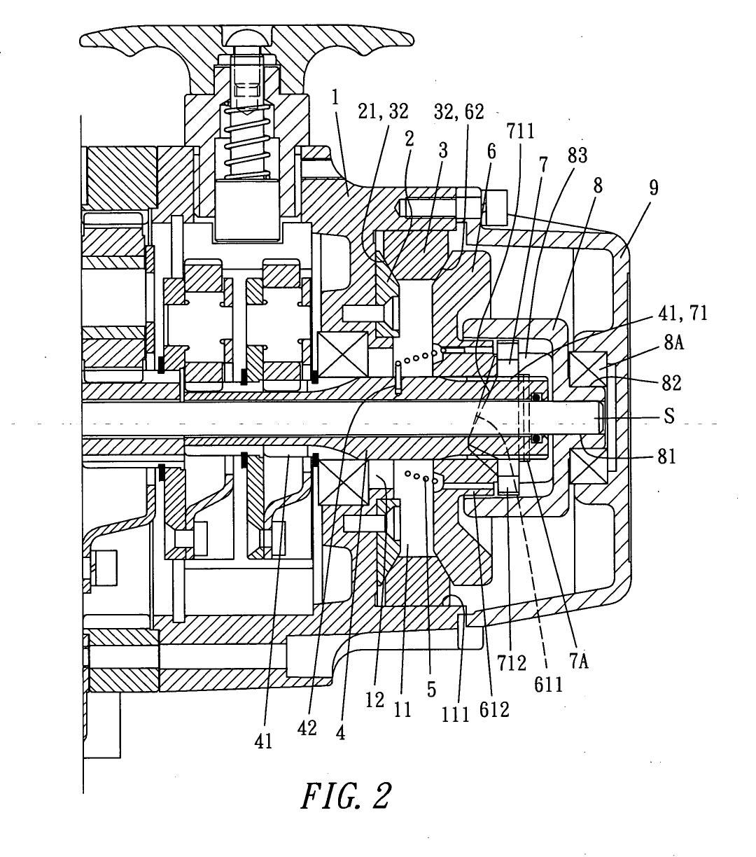

A preferred embodiment of a braking device for a power winch in the preset invention, as shown in FIGS. 1 and 2, includes a reduction box 1, a fixing base 2, a braking lining 3, a sectional shaft 4, an elastic member 5, a first engraved block 6, a second engraved block 7, a clutch base 8 and a reduction box rear cover 9 combined together.

The reduction box 1 secured on the power winch has its interior installed with a reduction gear set and its outer side bored with an accommodating hollow 11 having its inner side formed with a frictional surface. The reduction box further has its center bored with an insert hole for a motor spindle to pass therethrough, as shown in FIG. 2.

The fixing base 2 is fixed in the accommodating hollow 11 of the reduction box 1 by bolts and positioned around the circumference of the insert hole 12 of the accommodating hollow 11 but not contacting with the inner edge 111 of the accommodating hollow 11. Further, the fixing base 2 has its slanting circumferential edge formed with a frictional surface 21.

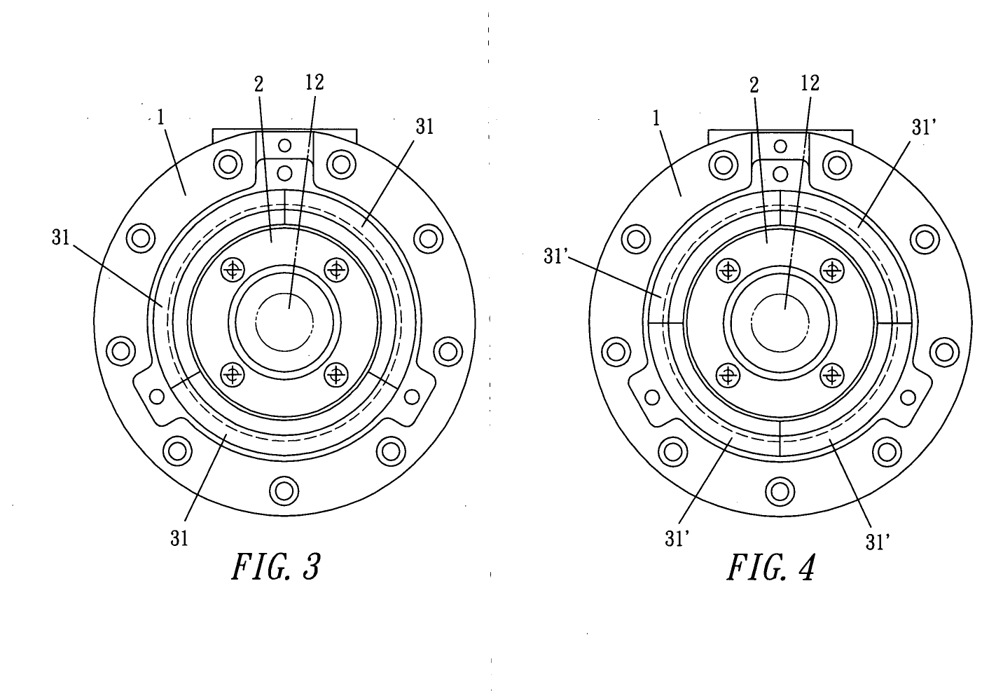

The braking lining 3 to be assembled in the accommodating hollow 11 of the reduction box 1 is composed of at least two blocks 31 able to be integrated to form a ring-shaped braking lining 3. Each block 31 has the opposite sides of its inner edge respectively formed with a slope 32, and one of the two slopes 32 abuts the frictional surface 21 of the fixing base 2; therefore, the gradients of the slope 32 of the block 31 and the frictional surface 21 of the fixing base 2 are preferably the same. In this preferred embodiment, the braking lining 3 is composed of three blocks 31, as shown in FIGS. 1 and 3, but substantially, the braking lining 3 could be composed of four or more blocks 31′ to be integrated to form a ring-shaped braking lining 3.

The sectional shaft 4 fitted on the motor spindle S (but unable to drive each other) is inserted in the insert hole 12 of the reduction box 1 and has the annular wall of its opposite ends formed with teeth 41. The teeth 41 on the annular wall of one end that is inserted in the insert hole 12 of the reduction box 1 are engaged with the reduction gear set in the reduction box 1 for rotating together.

The elastic member 5 is a volute spring fitted on the sectional shaft 4, having one end inserted and positioned in the hole 42 of the sectional shaft.

The first engraved block 6 is fitted on the sectional shaft 4 but unable to drive each other. The elastic member 5 has the other end inserted and positioned in the first engraved block 6. The first engraved block 6 is provided with an annular base 61 protruding outward on one side reverse to the elastic member 5. The annular base 61 is formed with plural corrugated slopes 611 and has its opposite outer walls respectively disposed with an actuating projection 612. The first engraved block 6 further has its outer circumferential edge formed with a slanting frictional surface 62 whose gradient is preferably the same as that of the inner circumferential edge 21 of the braking lining 2.

The second engraved block 7 is formed with a central hole having its inner wall provided with teeth 71 to be engaged with the teeth 41 on the annular wall of outer end of the sectional shaft 4 to enable the sectional shaft 4 and the second engraved block 7 to be rotated together. The second engraved block 7 is firmly positioned on the sectional shaft 4 by a set of C-shaped clasps 7A to prevent the second engraved block 7 from shifting. The second engraved block 7 is further provided with a slope 711 and two actuating projections 712 respectively corresponding with the slope 611 and the actuating projections 612 of the first engraved block 6, only there is slight angle error between the slopes 611, 711 and between the actuating projections 612, 712, such structure being the same as that of foresaid U.S. Pat. No. 6,520,486.

The clutch base 8 has its outer side bored with a central engage hole 81 to be engaged and combined with the outer end of the motor spindle S to enable the whole clutch base 8 to be driven to rotate by the motor spindle S. The engage hole 81 of the clutch base 8 has its outer circumferential edge formed with a bush base 82 for fitting a shaft bush 8A thereon. The clutch base 8 further has its inner side disposed with a set of symmetrical projecting blocks 83, as shown in FIG. 2, for respectively pushing the actuating projections 612, 712 of the first and the second engraved block 6, 7 to rotate.

The reduction box rear cover 9 is fixed on the reduction box 1 and fitted with the shaft bush 8A of the clutch base 8 so that the shaft bush 8A can firmly hold the outer side of the clutch base 8 to let the clutch base 8 rotated with great steadiness.

After being assembled, the braking lining composed of two or more blocks 32 is positioned between the inner edge of the accommodating hollow 11 and the frictional surface 21 of the fixing base 2 as well as the frictional surface 62 of the first engraved block 6, and the frictional surface 21 and 62 are respectively adjacent to one slope 32 of the braking lining 3 and contact with the slope 32 with a same gradient. Before carrying out braking, the braking lining is under a floating state due to allowance of size and separation of the first engraved block 6 from the braking lining 3, in other words, there is a gap formed between the inner edge of the accommodating hollow 11 and the fixing base 2 as well as the first engraved block 6.

To sling up the heavy load, simply press a ascending button to let the motor spindle S and the clutch base 8 rotate together, and simultaneously one projecting block 83 of the clutch base 8 will push the actuating projection 612, 712 of the first and the second engraved block 6, 7 to actuate the first and the second engraved block 6, 7 to rotate synchronously. At this time, the sectional shaft 4 will be actuated to rotate together with the second engraved block 7 to drive the reduction gear set to rotate and drive the rope drum of the power winch to turn and retract the steel rope for slinging up the heavy load. To lower down the heavy loads (or only to release the steel rope), only press a descending button to let the motor spindle S rotate reversely for releasing the steel rope and lowering down the heavy loads.

During slinging up or lowering down heavy loads, the motor can be stopped operating by pressing a stopping key, and the motor will automatically stop operating when power outage happens. When the motor stops operating, the motor spindle S and the clutch base 8 will stop rotating immediately and the projecting blocks 83 of the clutch base 8 will also stop pushing the first and the second engraved block 6, 7. At the instant, the reverse torsional force produced by the heavy loads hung on the steel rope will force the second engraved block 7 to push the first engraved block 6 to move (this action being the same as that described in the U.S. Pat. No. 6,520,486) to let the frictional surface 62 on the outer circumferential edge of the first engraved block 6 push against the slope 32 of each block 31 of the braking lining 3 and produce friction and braking action between them. Simultaneously, the blocks 31 of the braking lining 3 will be forced to move and contact with the frictional surface 21 of the fixing base 2 and the inner edge 111 of the accommodating hollow 11 to produce friction and braking action, that is, the braking lining 3 can instantly contact with the inner edge 111 of the accommodating hollow 11, the frictional surface 21 of the fixing base 2 and the frictional surface 62 of the first engraved block 6. Under such great friction and braking action, the first and the second engraved block 6, 7, the clutch base 8, the sectional shaft 4, the motor spindle S and the rope drum as well as the heavy load hung on the steel rope will stop movement immediately, letting the whole power winch completely stop functioning.

As can be noted from the above description, this invention has advantages described as follows.

1. The braking lining 3 is an independent component and it is under a floating state before carrying out braking; therefore, when the motor is started to operate, even if the first and the second engraved block 6, 7 are rotated, the braking lining 3 will not be actuated to rotate so it will be free from wear.

2. Only when the motor stops operating, will the braking lining 3 contact with the frictional surface 62 of the first engraved block 6 and the frictional surface 21 of the fixing base 2 as well as with the inner edge 111 of the accommodating hollow 11 and begin to function, able to prevent wear and prolong service life and having excellent effect on braking.

3. In case the braking lining 3 should be damaged, only the braking lining 3 has to be replaced without involving other components, conforming to economic gain.

4. The braking lining 3 can be replaced with a new one easily and conveniently, having great practicability.

While the preferred embodiment of the invention has been described above, it will be recognized and understood that various modifications may be made therein and the appended claim are intended to cover all such modifications that may fall within the spirit and scope of the invention.

I claim:

1. A braking device for a power winch comprising:
a reduction box secured on a power winch, said reduction box having a reduction gear set disposed in the interior, said reduction box having its outer side formed with an accommodating hollow and its center bored with an insert hole for a motor spindle to pass therethrough, said reduction gear set received in said insert hole;
a fixing base fixed in said accommodating hollow of said reduction box, said fixing base formed with a frictional surface;
a braking lining composed of at least two blocks to be integrated to form a ring-shaped braking lining, said braking lining assembled in said accommodating hollow of said reduction box, said braking lining positioned adjacent to the inner edge of said accommodating hollow and said frictional surface of said fixing base, with a small gap formed between them;
a sectional shaft fitted on said motor spindle and having one end inserted in said insert hole of said reduction box, said shaft having the annular wall of its opposite ends provided with teeth, said teeth on said annular wall of one end, which is inserted in said insert hole, engaged with said reduction gear set for rotating together;
an elastic member fitted on said sectional shaft, said elastic member having one end inserted and positioned in the hole of said sectional shaft;
a first engraved block fitted on said sectional shaft, said elastic member having the other end inserted and positioned in said first engraved block, said first engraved block disposed with a protruding annular base on one side reverse to said elastic member, said annular base formed with plural corrugated slopes and having its outer wall fixed with two symmetrical actuating projections, said first engraved block having its outer circumferential edge formed with a frictional surface abutting said braking lining, letting said braking lining lying between said accommodating hollow and said fixing base as well as said first engraved block;
a second engraved block formed with a central hole having its inner wall provided with teeth to be engaged with said teeth on one said annular wall of said sectional shaft, said second engraved block provided with a slope and two actuating projections respectively corresponding with said slope and said two actuating projections of said first engraved block, there being slight angle error between said slopes and between said actuating projecting of said first and said second engraved block;
a clutch base bored with an engage hole in the center to be engaged and combined with the outer end of said motor spindle, said clutch base having its inner side disposed with two projecting blocks for pushing said actuating projections of said first and said second engraved block;
a reduction box rear cover locked and positioned on said reduction box; and
said braking lining being an independent component assembled in said accommodating hollow of said reduction box, said braking lining positioned between the inner edge of said accommodating hollow and said frictional surface of said fixing base as well as said frictional surface of said first engraved block, said braking lining being under a floating state before performing braking, said first engraved block pushed to move and have said frictional surface contacting with said braking lining when the motor stops operating, said blocks of said braking lining pressed to move and contact with said frictional surface of said fixing base and said frictional surface on the inner edge of said accommodating hollow and carry out braking.
